(19) United States
(12) Patent Application Publication
(10) Pub. No.: US 2006/0204831 A1
(43) Pub. Date: Sep. 14, 2006

(54) Control parameters for optimizing MEA performance

(76) Inventors: Susan G. Yan, Fairport, NY (US); John C. Doyle, Bergen, NY (US); Bhaskar Sompalli, Rochester, NY (US); Hubert A. Gasteiger, Rochester, NY (US); Jeanette E. O'Hara, Honeoye, NY (US); Wenbin Gu, Pittsford, NY (US)

Correspondence Address: CHARLES H. ELLERBROCK;General Motors Corporation, Legal Staff, Mail Code 482-C23-B21, P.O. Box 300, Detroit, MI, 48265-3000, US

(21) Appl. No.: 11/434,326

(22) Filed: May 15, 2006

Related U.S. Application Data
(63) Continuation-in-part of application No. 10/763,633, filed on Jan. 22, 2004.

(51) Int. Cl. H01M 4/86; H01M 4/96; H01M 4/94; B05D 5/12; H01M 4/88

(52) U.S. Cl. 429/42; 429/44; 427/115; 502/101

(57) ABSTRACT

A gradient of ionomeric material is generated, disposed, or otherwise provided in an electrode suitable for use in a fuel cell. The ionomer concentration, e.g., with respect to the carbon content of the catalyst layer (e.g., expressed as a ratio), is greatest in the area closest to the membrane, e.g., of the fuel cell (e.g., the membrane side), and is decreased in the area furthest from the membrane (e.g., the gas side). By way of another non-limiting example, the ionomer gradient can be formed such that the concentration (or the ratio if expressed in relation to the carbon content of the catalyst layer) can gradually, as opposed to rapidly, decrease as the distance away from the membrane increases.

### CROSS-REFERENCE TO RELATED APPLICATION

The instant application is a continuation-in-part of U.S. patent application Ser. No. 10/763,633, filed Jan. 22, 2004, the entire specification of which is expressly incorporated herein by reference.

### FIELD OF THE INVENTION

The present invention relates generally to a membrane electrode assembly (MEA) for a proton exchange membrane fuel cell and, more particularly, to an MEA for a proton exchange membrane fuel cell, where the anode and/or cathode catalyst layers are formed on a porous and/or non-porous support wherein an ionomer material is incorporated therein in a gradient having a relatively high ionomer content closest to the membrane layer and a relatively low ionomer content layer furthest from the membrane layer. Additionally, the present invention relates to the formation of ionomer gradients in conjunction with catalyst coated diffusion media, wherein the catalyst coated diffusion media are hot pressed to a membrane, which may also be provided with a catalyst layer formed thereon.

### BACKGROUND OF THE INVENTION

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is oxidized in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus, are directed through a load to perform work before being sent to the cathode.

Proton exchange membrane fuel cells (PEMFC) generally include a solid polymer electrolyte proton conducting membrane, such as a perfluorosulfonic acid membrane. The anode and the cathode typically include finely divided catalytic particles, usually platinum (Pt), supported on carbon particles and mixed with an ionomer and a solvent. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Examples of technology related to PEM and other related types of fuel cell systems can be found with reference to commonly-assigned U.S. Pat. No. 3,985,578 to Witherspoon et al.; U.S. Pat. No. 5,624,769 to Li et al.; U.S. Pat. No. 5,776,624 to Neutzler; U.S. Pat. No. 6,277,513 to Swathirajan et al.; U.S. Pat. No. 6,350,539 to Wood, III et al.; U.S. Pat. No. 6,372,376 to Fronk et al.; U.S. Pat. No. 6,376,111 to Mathias et al.; U.S. Pat. No. 6,521,381 to Vyas et al.; U.S. Pat. No. 6,524,736 to Sompalli et al.; U.S. Pat. No. 6,566,004 to Fly et al.; U.S. Pat. No. 6,663,994 to Fly et al.; U.S. Pat. No. 6,793,544 to Brady et al.; U.S. Pat. No. 6,794,068 to Rapaport et al.; U.S. Pat. No. 6,811,918 to Blunk et al.; U.S. Pat. No. 6,824,909 to Mathias et al.; U.S. Patent Application Publication Nos. 2004/0009384 to Mathias et al.; 2004/0096709 to Darling et al.; 2004/0137311 to Mathias et al.; 2005/0026012 to O'Hara; 2005/0026018 to O'Hara et al.; 2005/0026523 to O'Hara et al.; 2005/0042500 to Mathias et al.; 2005/0084742 to Angelopoulos et al.; 2005/0100774 to Abd Elhamid et al.; 2005/0112449 to Mathias et al., 2005/0163920 to Yan et al.; and 2005/0164072 to Yan et al., the entire specifications of all of which are expressly incorporated herein by reference.

It is generally known in the MEA art to coat the catalyst layer on the polymer electrolyte membrane. The catalyst layer may be deposited directly on the membrane, or indirectly applied to the membrane by first coating the catalyst on a decal substrate. Typically, the catalyst is coated on the decal substrate as a slurry by a rolling process. The catalyst is then transferred to the membrane by a hot-pressing step. This type of MEA fabrication process is sometimes referred to as a catalyst coated membrane (CCM). Other fabrication techniques include the coating of a catalyst layer on a diffusion media to form a catalyst coated diffusion media (CCDM), as well as a combination of CCMs and CCDMs.

After the catalyst is coated on the decal substrate, an ionomer layer is sometimes sprayed over the catalyst layer before it is transferred to the membrane. Even though both the catalyst layer and the membrane contain the ionomer, the ionomer spray layer provides a better contact between the catalyst and the membrane, because it decreases the contact resistance between the catalyst and the membrane. This increases the proton exchange between the membrane and the catalyst, and thus, increases fuel cell performance.

The decal substrate can be a porous expanded polytetrafluoroethylene (ePTFE) decal substrate. Alternatively, the porous decal substrate can be comprised of porous polyethylene, porous polypropylene, and/or the like without or with appropriate surface coatings. However, the ePTFE substrate is expensive and not reusable. Particularly, when the catalyst is transferred to the membrane on the ePTFE substrate, a certain portion of the ionomer remains in the ePTFE substrate. Additionally, the ePTFE substrate stretches, deforms and absorbs solvents making a cleaning step very difficult. Hence, every ePTFE substrate used to make each anode and cathode is discarded.

The decal substrate can also be a non-porous ethylene tetrafluoroethylene (ETFE) decal substrate. Alternatively, the non-porous decal substrate can be comprised of PET, PTFE and/or the like. The ETFE decal substrate provides minimal loss of catalyst and ionomer to the substrate because virtually all of the coating is decal transferred. The substrate does not deform and can be reused.

In another known fabrication technique, the MEA is prepared as a CCDM instead of a CCM. The diffusion media is a porous layer that is necessary for gas and water transport through the MEA. The diffusion media is typically a carbon paper substrate that is coated with a microporous layer, where the microporous layer is a mixture of carbon and fluoropolymer (e.g., FEP, PVDF, HFP, PTFE and/or the like). A catalyst ink is typically coated on top of the microporous layer, and may be sprayed with ionomer solution. A piece of bare perfluorinated membrane is sandwiched between two pieces of the CCDM with the catalyst sides facing the membrane, and then hot-pressed to bond the CCDM to the membrane.

One approach to manufacturing robust MEAs can be found in commonly assigned U.S. Pat. No. 6,524,736 to Sompalli et al., the entire specification of which is expressly incorporated herein by reference. This approach including a process to manufacture MEAs by coating catalyst inks on porous expanded-PTFE supports or webs to generate electrodes with a uniform distribution of the ionomeric binder, as shown in FIGS. 1-2a. The concept of over-spraying to aid good transfer of catalyst to membrane (e.g., to act as an adhesive) was also described.

Referring to FIG. 1, there is shown a coated catalyst layer 10 (e.g., a platinum/carbon support with an ionomeric binder) disposed on a porous expanded PTFE support 12. Referring to FIGS. 2 and 2a, there is shown a membrane electrode assembly 20 including an anode portion 22, a cathode portion 24, and a membrane (e.g., ionomeric) portion 26 disposed in between. Each electrode portion, anode and/or cathode, includes a membrane side 28 nearest the membrane portion 26 and a gas side 30 furthest from the membrane portion 26. Referring specifically to FIG. 2a, the concentration of any ionomeric material in the respective electrodes (e.g., anode and/or cathode) is relatively uniform throughout the thickness of the electrode, i.e., the concentration does not vary considerably from the membrane side 28 towards the gas side 30, e.g., in the direction of the arrow, as indicated by line 25.

However, there still exists a need for techniques for fabricating MEAs that are simplified, result in more durable MEAs than those MEAs known in the art, and which provide for greater control of the ionomeric distribution in the electrodes.

### SUMMARY OF THE INVENTION

In accordance with a first embodiment of the present invention, an electrode catalyst layer for use in a fuel cell is provided, comprising: (1) a catalyst portion; and (2) an ionomeric material disposed in the catalyst portion, wherein the concentration of the ionomeric material forms a gradient wherein the concentration of the ionomeric material decreases or increases with respect to a first surface of the catalyst portion to a second spaced and opposed surface of the catalyst portion.

In accordance with a first alternative embodiment of the present invention, a catalyst-coated membrane is provided, comprising an electrode catalyst layer disposed on a surface of the membrane, wherein the electrode catalyst layer comprises: (1) a catalyst portion; and (2) an ionomeric material disposed in the catalyst portion, wherein the concentration of the ionomeric material forms a gradient wherein the concentration of the ionomeric material is highest in proximity to the surface of the membrane.

In accordance with a second alternative embodiment of the present invention, a catalyst-coated diffusion medium is provided, comprising an electrode catalyst layer disposed on a surface of the diffusion medium, wherein the electrode catalyst layer comprises: (1) a catalyst portion; and (2) an ionomeric material disposed in the catalyst portion, wherein the concentration of the ionomeric material forms a gradient wherein the concentration of the ionomeric material is lowest in proximity to the surface of the diffusion medium.

In accordance with a third alternative embodiment of the present invention, a membrane electrode assembly is provided, comprising: (1) a membrane; (2) a cathode catalyst layer; and (3) an anode catalyst layer, wherein either the anode or cathode catalyst layer is disposed on a surface of the membrane, wherein either anode or cathode catalyst layer comprises: (a) a catalyst portion; and (b) an ionomeric material disposed in the catalyst portion, wherein the concentration of the ionomeric material forms a gradient wherein the concentration of the ionomeric material is highest in proximity to the surface of the membrane.

In accordance with a fourth alternative embodiment of the present invention, a membrane electrode assembly is provided, comprising: (1) a membrane; (2) a catalyst layer; and (3) a diffusion medium, wherein the catalyst layer is disposed on a surface of either the membrane or the diffusion medium, wherein the catalyst layer comprises: (a) a catalyst portion; and (b) an ionomeric material disposed in the catalyst portion, wherein the concentration of the ionomeric material forms a gradient wherein the concentration of the ionomeric material is highest in proximity to the surface of the membrane.

In accordance with a fifth alternative embodiment of the present invention, a method of forming an electrode catalyst layer for use in a fuel cell is provided, comprising: (1) providing a catalyst portion, wherein the catalyst portion includes a solvent and an ionomeric material; (2) coating the catalyst portion onto a surface of a substrate; and (3) drying the solvent, wherein the ionomeric material is operable to migrate through the catalyst portion so as to form a gradient therein.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a partial schematic view of a coated catalyst layer on a porous expanded PTFE support, in accordance with the prior art;

FIG. 2 illustrates a partial schematic view of a membrane electrode assembly, in accordance with the prior art;

FIG. 2a illustrates a detailed portion of the membrane electrode assembly depicted in FIG. 2, in accordance with the prior art;

FIG. 3 illustrates a partial schematic view of a coated catalyst layer on a porous expanded PTFE support, in accordance with a first embodiment of the present invention;

FIG. 3a illustrates a partial schematic view of a membrane electrode assembly, in accordance with a first embodiment of the present invention;

FIG. 3b illustrates a detailed portion of the membrane electrode assembly depicted in FIG. 3a, in accordance with a first embodiment of the present invention;

FIG. 4 illustrates a partial schematic view of a coated catalyst layer on a porous expanded PTFE support, in accordance with a first alternative embodiment of the present invention;

FIG. 5 Illustrates a graphical view of the effect of a solvent in the overspray solution on the ionomeric gradient in a membrane electrode assembly, in accordance with a second alternative embodiment of the present invention;

FIG. 6 illustrates a graphical view of the effect of the volume of the ionomeric overspray on membrane electrode assembly performance, in accordance with a third alternative embodiment of the present invention;

FIG. 6a illustrates a partial schematic view of a coated catalyst layer on a gas diffusion media substrate coated with a microporous layer, in accordance with a fourth alternative embodiment of the present invention;

FIG. 6b illustrates a graphical view of the effect of a solvent in the overspray solution on the ionomeric gradient in a membrane electrode assembly, in accordance with a fifth alternative embodiment of the present invention;

FIG. 7 illustrates a partial schematic view of a coated catalyst layer on a non-porous support, in accordance with a sixth alternative embodiment of the present invention;

FIG. 8 illustrates a graphical view of the effect of the solvent composition in the ionomeric overspray on the ionomeric gradient in the membrane electrode assembly, in accordance with a seventh alternative embodiment of the present invention;

FIG. 9 illustrates a partial schematic view of a coated catalyst layer on a porous expanded EPTFE support, in accordance with an eighth alternative embodiment of the present invention;

FIG. 9a illustrates a partial schematic view of the coated catalyst layer on a porous expanded EPTFE support depicted in FIG. 9a showing the migration of solvent and ionomer, in accordance with an eighth alternative embodiment of the present invention;

FIG. 9b illustrates a detailed portion of a membrane electrode assembly, in accordance with an eighth alternative embodiment of the present invention;

FIG. 9c illustrates a graphical view of the effect of the use of n-butanol and n-propanol solvents to control ionomeric intrusion and set up a continuous ionomer gradient, in accordance with an eighth alternative embodiment of the present invention;

FIG. 10 illustrates a partial schematic view of a coated catalyst layer on a non-porous decal, in accordance with a ninth alternative embodiment of the present invention;

FIG. 11 illustrates a detailed portion of a membrane electrode assembly, in accordance with the ninth alternative embodiment of the present invention;

FIG. 12a illustrates a schematic view of a coated catalyst layer having a high ionomeric/carbon ratio on a decal, in accordance with a tenth alternative embodiment of the present invention;

FIG. 12b illustrates a schematic view of a coated catalyst layer having a low ionomeric/carbon ratio on a decal, in accordance with a tenth alternative embodiment of the present invention;

FIG. 12c illustrates a partial schematic view of a coated catalyst layer having a high ionomeric/carbon ratio hot-pressed onto a membrane layer, in accordance with a tenth alternative embodiment of the present invention;

FIG. 12d illustrates a partial schematic view of a coated catalyst layer having a low ionomeric/carbon ratio hot-pressed onto a coated catalyst layer having a high ionomeric/carbon ratio, in accordance with a tenth alternative embodiment of the present invention;

FIG. 13 illustrates a graphical view of the performance of membrane electrode assemblies having electrodes prepared in accordance with the general teachings of the present invention, in accordance with an eleventh alternative embodiment of the present invention;

FIG. 14 illustrates a graphical view of the effect of hot pressing temperature on fuel cell performance at moderate conditions, in accordance with a twelfth alternative embodiment of the present invention;

FIG. 15 illustrates a graphical view of the effect of hot pressing temperature on fuel cell performance at very humidified conditions, in accordance with a thirteenth alternative embodiment of the present invention;

FIG. 16a illustrates a schematic view of a catalyst coated decal with a high ionomeric/carbon ratio on a decal, in accordance with a fourteenth alternative embodiment of the present invention;

FIG. 16b illustrates a schematic view of a catalyst coated diffusion media having a low ionomeric/carbon ratio, in accordance with a fourteenth alternative embodiment of the present invention;

FIG. 16c illustrates a schematic view of the product of a first hot-pressing step in which the high ionomeric catalyst layer is transferred to the membrane, in accordance with a fourteenth alternative embodiment of the present invention; and

FIG. 16d illustrates a schematic view of the product of a second hot-pressing step in which the lower ionomeric catalyst layer is laminated to the high ionomer catalyst layer, in accordance with a fourteenth alternative embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

In accordance with the general teachings of the present invention, a gradient of ionomeric material is generated, disposed, or otherwise provided in the electrode, e.g., when bonded to the membrane. That is, a gradient exists with respect to the ionomeric material vis-à-vis the membrane. By way of a non-limiting example, the ionomer concentration, e.g., with respect to the carbon content of the catalyst layer (e.g., expressed as a ratio), is greatest in the area closest to the membrane (e.g., the membrane side) and is decreased in the area furthest from the membrane (e.g., the gas side). By way of another non-limiting example, the ionomer gradient can be formed such that the concentration (or the ratio if expressed in relation to the carbon content of the catalyst layer) can gradually, as opposed to rapidly, decrease as the distance from the membrane increases.

In accordance with one aspect of the present invention, there is a relatively high ionomeric content in the catalyst layer closest to the membrane (i.e., the membrane side). By way of a non-limiting example, the ionomer/carbon (I/C) ratio (e.g., in the electrode) is in the range of about 0.8 to about 3. By way of another non-limiting example, the ionomer/carbon (I/C) ratio (e.g., in the electrode) is in the range of about 1 to about 2.

In accordance with another aspect of the present invention, there is a relatively low ionomeric content in the catalyst layer furthest from the membrane (i.e., the gas side). By way of a non-limiting example, the ionomer/carbon (I/C) ratio (e.g., in the electrode) is in the range of about 0.1 to about 1.0. By way of another non-limiting example, the ionomer/carbon (I/C) ratio (e.g., in the electrode) is in the range of about 0.2 to about 0.8.

There are multiple approaches to generate such gradients in the catalyst layer. By way of a non-limiting example, several approaches compatible with the general teachings of the present invention are presented below.

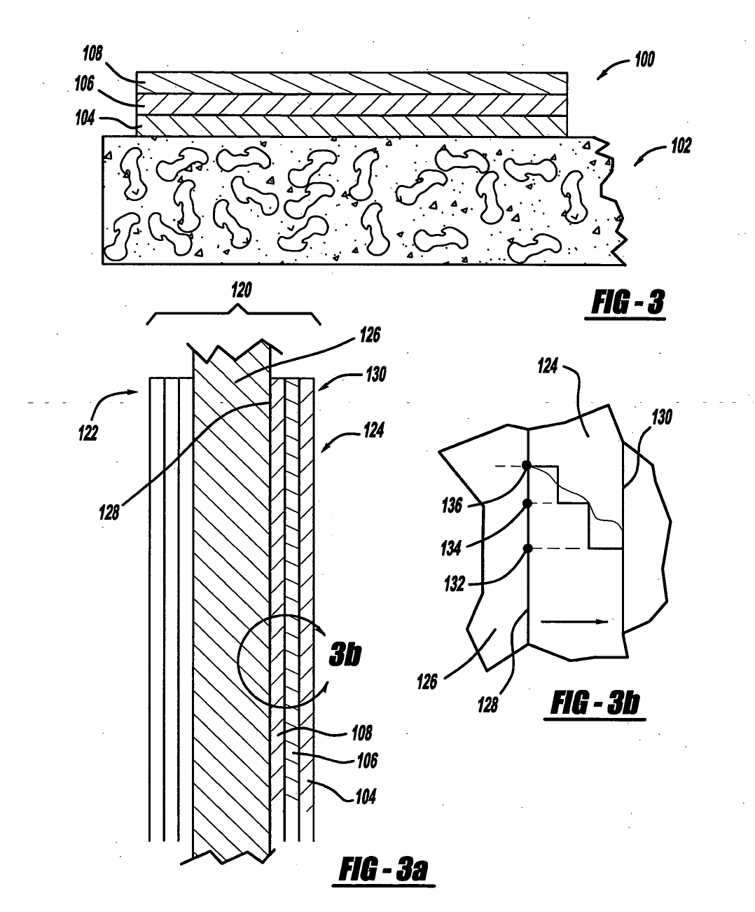

One approach includes the technique of coating multiple layers of catalyst onto a porous and/or non-porous decal support/web. By way of a non-limiting example, the layer closest to the web would have the lowest ionomer content (e.g., an I/C ratio equal to about 0.5/1). The ionomer content could be progressively increased by coating multiple times with inks which have increasing ionomeric content. It is to be noted that the catalyst layers should be dried before another coating of ink is applied. This would generate a composite catalyst layer which has a structure with progressively increasing ionomeric content, as shown in FIGS. 3-3b.

Referring to FIG. 3, there is shown a coated catalyst layer 100 disposed on a porous expanded PTFE support 102. The coated catalyst layer 100 includes a relatively low ionomeric content layer 104 (e.g., an I/C ratio of about 0.5/1) closest to the support 102, an intermediate ionomeric content layer 106 (e.g., an I/C ratio of about 1/1), and a relatively high ionomeric content layer 108 (e.g., an I/C ratio of about 1.5/1) furthest from the support 102. Referring to FIG. 3a, there is shown a membrane electrode assembly 120 including an anode portion 122, a cathode portion 124, and a membrane portion 126 disposed therebetween. Each electrode portion, anode and/or cathode, includes a membrane side 128 nearest the membrane portion 126 and a gas side 130 furthest from the membrane portion 126. Either electrode can include the arrangement of ionomeric layers as depicted in FIG. 3a. In this view, the cathode portion 124 includes a relatively high ionomeric content layer 108 (e.g., an I/C ratio of about 1.5/1) closest to the membrane portion 126, an intermediate ionomeric content layer 106 (e.g., an I/C ratio of about 1/1), and a relatively low ionomeric content layer 104 (e.g., an I/C ratio of about 0.5/1) furthest from the membrane portion 126. It should be appreciated, however, that the ionomeric layer gradient can be achieved with a single discrete layer or a plurality of layers. Referring to FIG. 3b, the concentration of any ionomeric material in the respective electrodes (e.g., anode and/or cathode) gradually decreases throughout the thickness of the electrode, i.e., the concentration varies considerably from the membrane side 128 towards the gas side 130, e.g., in the direction of the arrow, providing a “high” zone 136 (e.g., an I/C ratio of about 1.5/1), an “intermediate” zone 134 (e.g., an I/C ratio of about 1/1), and a “low” zone 132 (e.g., an I/C ratio of about 0.5/1). Again, it should be appreciated that the ionomeric layer gradient can be achieved with a single discrete layer or a plurality of layers, e.g., as shown in FIG. 3a. That is, for example, the gradient zones can be contained within a single layer or a plurality of layers.

Thus, a multiple coating approach would achieve a stepwise increase in ionomer content, as shown in FIG. 3b. Without being bound to a particular theory of the operation of the present invention, it is believed that the solvents in the repeat coating inks would seep into the underlying dried catalyst layer, and cause some intermixing of the ionomers (e.g., as shown by the curved line in FIG. 3b). Such intermixing can also occur during the hot-pressing step. Such intermixing would serve to create a smooth transition from relatively low to relatively high ionomeric content. It is to be noted that this method can also be used when the support is not porous. For example, the ionomeric gradient is created by the ionomer content in the multiple catalyst layers, and has little to do with the porosity of the support. Thus, switching from a porous to a non-porous support would have little impact on the step-change of ionomer content in the catalyst structure.

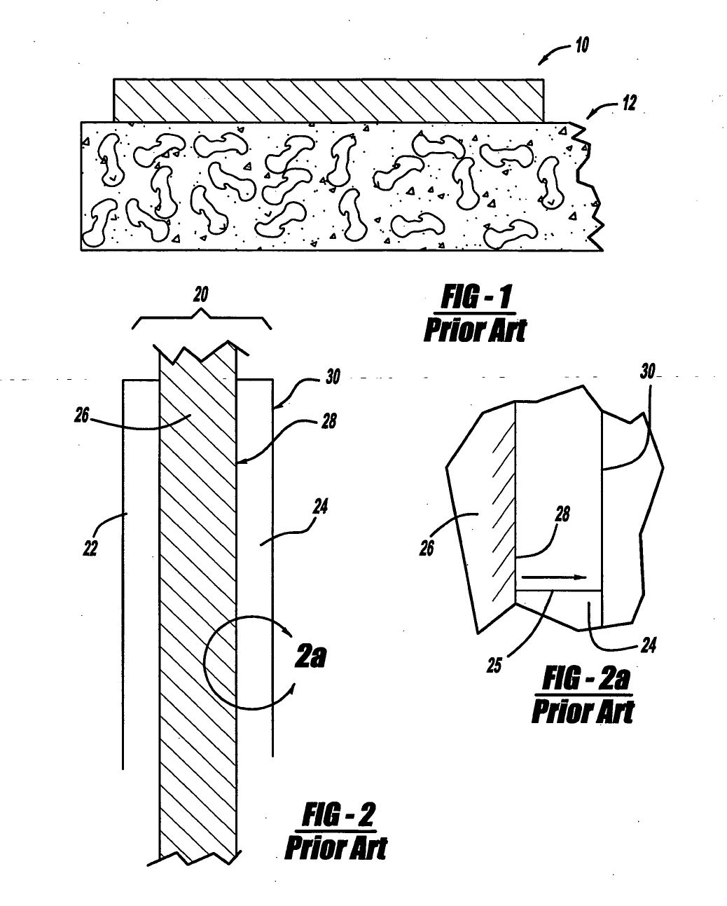

Another approach is the use of different solvent systems in the overspray solution used on electrodes. By way of a non-limiting example, this method is meant for use with porous supports. It is now known that the porous support aids in solvent removal and uniform drying of the catalyst layer, e.g., as shown in FIG. 1. The porosity of the support can also be utilized for generation of a continuous ionomer gradient, instead of a stepwise increase as suggested in the previously described approach.

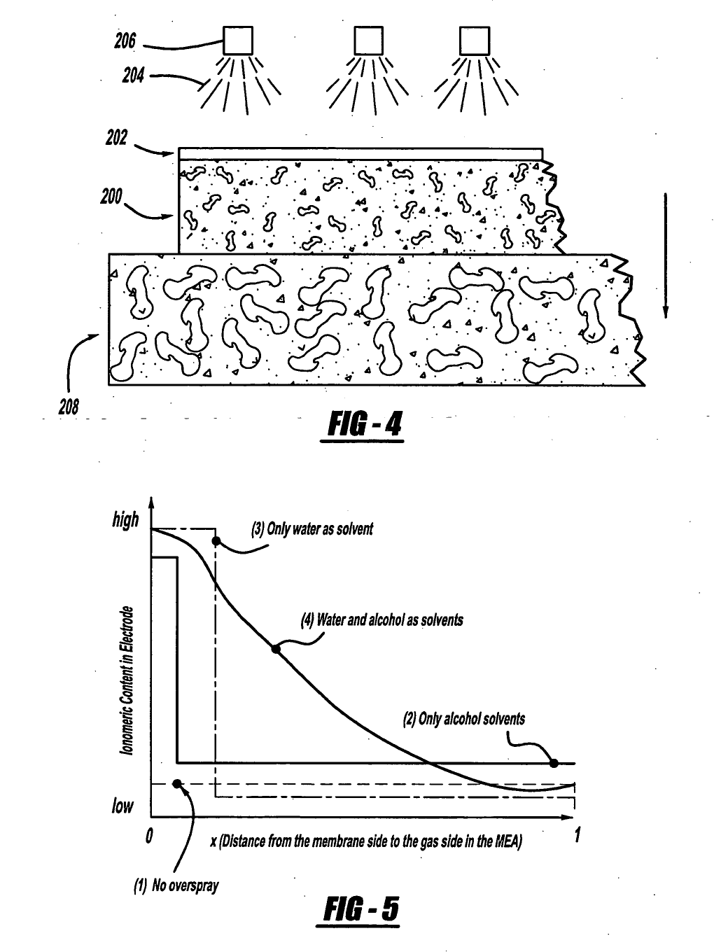

Referring to FIG. 4, there is shown a catalyst layer 200 having an ionomeric layer 202 sprayed therein (e.g., with an overspray ionomeric solution 204 via nozzles 206), with a porous expanded PTFE support 208. The over-spraying of the ionomer solution, which increases the ionomeric content in the electrodes, can also be used to create an ionomeric gradient in the electrode. For example, the solvent content in the overspray solution governs the extent of ionomer intrusion into the electrodes. The phrase “ionomer intrusion or penetration” refers to the ionomer intrusion into the electrode (e.g., in the direction of the arrow), and possibly into the porous support, as shown in FIG. 4.

The use of alcohols as solvents (e.g., isopropyl, ethanol, methanol, and/or the like) increases the extent of ionomer penetration into the catalyst layer coated on the porous decal. The use of non-wetting solvents (e.g., water) reduces the ionomer penetration into the electrode. Thus, increasing the ionomer content in the electrode by spraying, and use of mixture of water and alcohols, would increase the extent of ionomer penetration into the electrode, and could help set up a continuous gradient, as shown in FIG. 5.

Additionally, the use of alcohols as solvents (e.g., isopropyl, ethanol, methanol, and/or the like) increases the extent of ionomer penetration into the porous decal. The use of non-wetting solvents (e.g., water) reduces the ionomer penetration into the porous support. Thus, increasing the ionomer content in the spraying solution, and use of mixture of water and alcohols, would increase the extent of ionomer penetration into the porous support, and could further help set up a continuous gradient, as shown in FIG. 5.

Use of water reduces the ionomer penetration, because expanded PTFE (e.g., porous PTFE support) is hydrophobic and repels water.

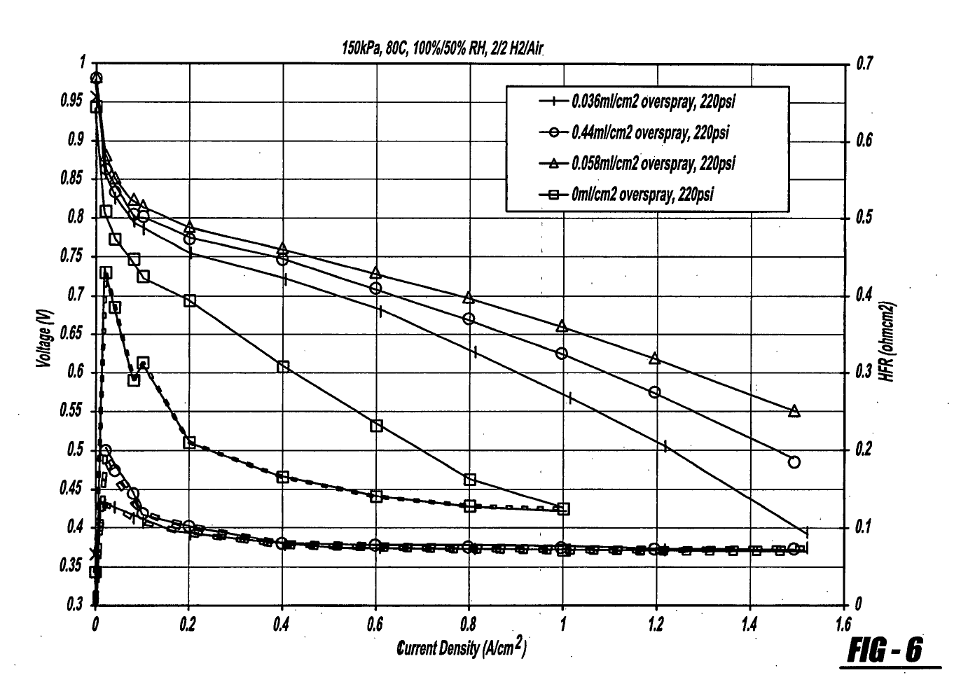

Additionally, the volume of ionomer sprayed also governs the performance of the resulting electrode, as shown in FIG. 6. For example, the spray volume translates directly into the amount of ionomer deposited by ionomer overspray.

Another approach is the use of gas diffusion media substrates (e.g., woven or non-woven carbon fiber papers or woven carbon cloth) coated with a microporous layer (e.g., a matrix of carbon and/or graphite with a fluoropolymer). It is now known that the gas diffusion media substrate coated with a microporous layer aids in solvent removal and uniform drying of the catalyst layer. The porosity of the gas diffusion media substrates coated with a microporous layer can also be utilized for generation of a continuous ionomer gradient, instead of a stepwise increase as suggested in the previously described approach.

Referring to FIG. 6a, there is shown a catalyst layer 200 having an ionomeric layer 202 sprayed therein (e.g., with an overspray ionomeric solution 204 via nozzles 206), with a gas diffusion media substrate 208a coated with a microporous layer support 208b. The over-spraying of the ionomer solution, which increases the ionomeric content in the electrodes, can also be used to create an ionomeric gradient in the electrode. For example, the solvent content in the overspray solution governs the extent of ionomer intrusion into the electrodes. The phrase “ionomer intrusion or penetration” refers to the ionomer intrusion into the electrode (e.g., in the direction of the arrow), and possibly into the gas diffusion media substrate coated with a microporous layer.

The use of alcohols as solvents (e.g., isopropyl, ethanol, methanol, and/or the like) increases the extent of ionomer penetration into the catalyst layer coated on the porous MPL/DM. The use of non-wetting solvents (e.g., water) reduces the ionomer penetration into the electrode. Thus, increasing the ionomer content in the electrode by spraying, and use of mixture of water and alcohols, would increase the extent of ionomer penetration into the electrode, and could help set up a continuous gradient, as shown in FIG. 6b.

Additionally, the use of alcohols as solvents (e.g., isopropyl, ethanol, methanol, and/or the like) increases the extent of ionomer penetration into the porous MPL/DM. The use of non-wetting solvents (e.g., water) reduces the ionomer penetration into the porous MPL/DM. Thus, increasing the ionomer content in the spraying solution, and use of mixture of water and alcohols, would increase the extent of ionomer penetration into the porous MPL/DM, and could further help set up a continuous gradient, as shown in FIG. 6b.

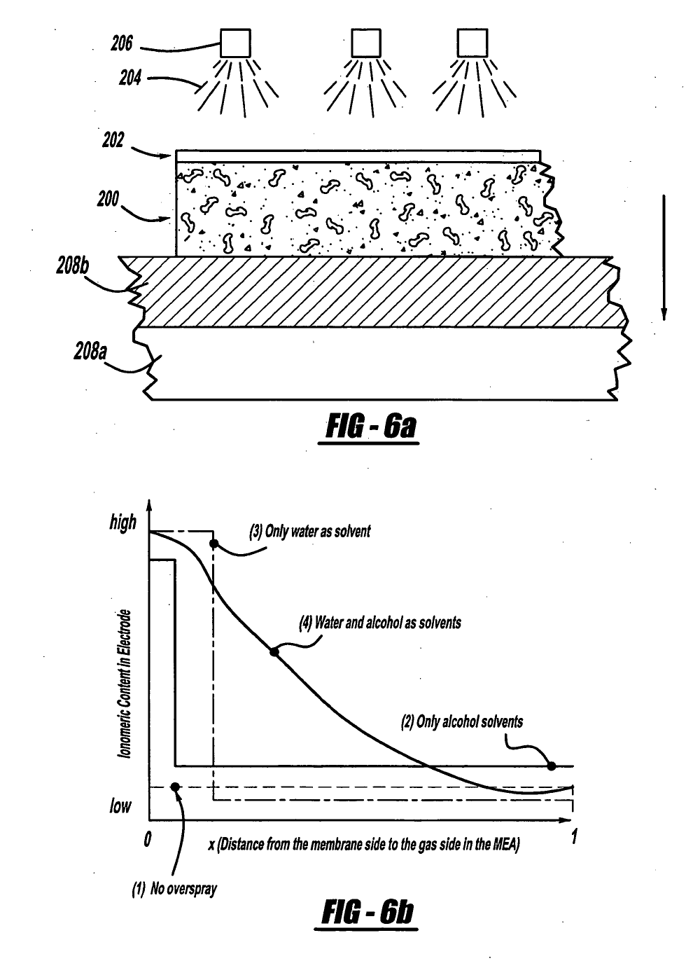

Referring to FIG. 7, there is shown a catalyst layer 300 having an ionomeric layer 302 sprayed therein (e.g., with an overspray ionomeric solution 304 via nozzles 306), with a non-porous support 308. As noted, one of the previous methods uses a porous support. The use of solvents in the spray to create a continuous ionomer gradient can be also on a non-porous decal. As shown in FIGS. 7 and 8, the control of solvent composition in the ionomer overspray solution sets up an ionomer gradient in the electrode. Similar solvent systems can also be used. Without being bound to a particular theory of the operation of the present invention, similar effect as that shown in FIGS. 6 and 6b can be expected in this case too.

Another method is using controlled drying to create continuous ionomer gradients. This method applies to all of the described embodiments. Control of drying could also help set up a continuous gradient. This would require an appropriate selection of solvents and drying procedures. Appropriate solvents are required, including, but not limited to water, methanol, ethanol, iso-propanol, n-butanol, higher boiling point alcohols than butanol, such as ethylene glycol, glycerin, glycerol, and/or the like.

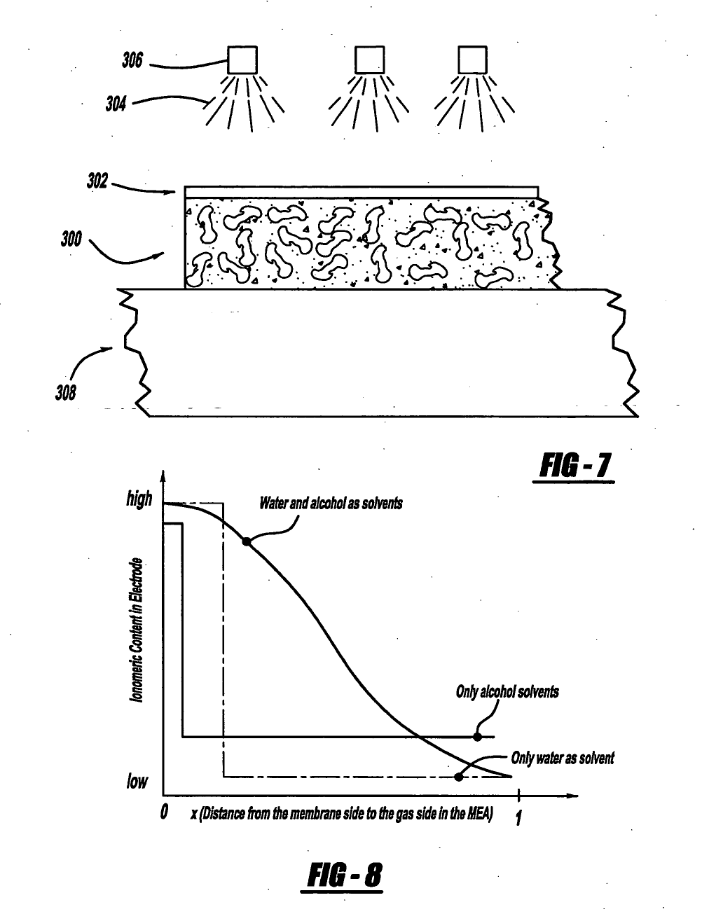

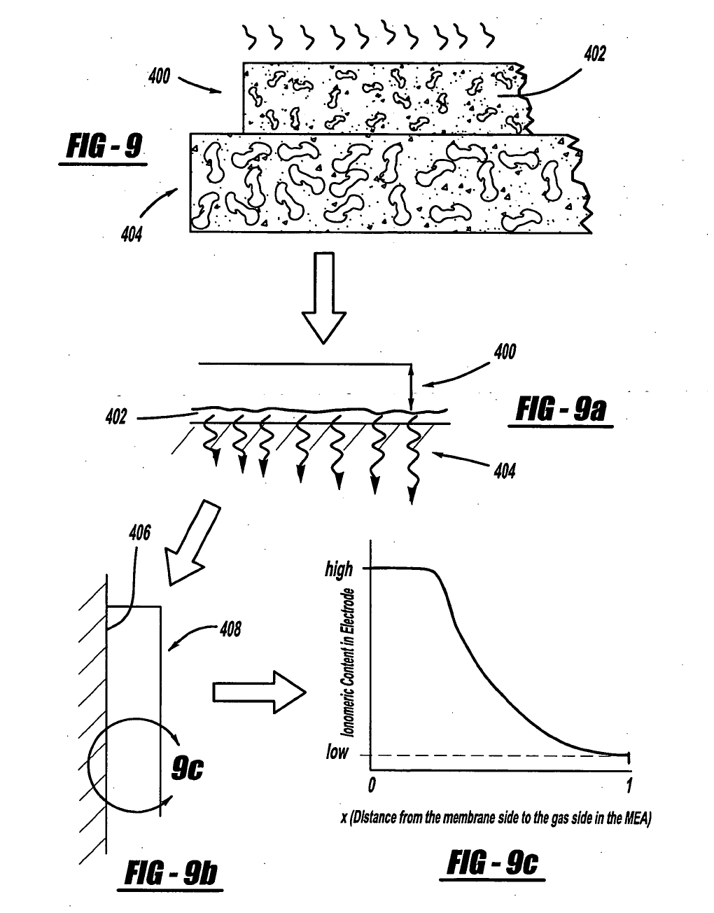

Referring to FIG. 9, there is shown a catalyst layer 400 having an ionomeric material 402 contained therein, disposed on a porous ePTFE support 404. By way of a non-limiting example, a mixture of n-butanol (e.g., which evaporates very slowly) and iso-propanol (e.g., which evaporates very quickly) could help provide for increased penetration toward the bottom of the decal (e.g., closest to the web), while leaving a majority of the ionomer intact in the electrode (e.g., closest to the membrane), as shown in FIG. 9a. Accordingly, the ionomer concentration closest to the membrane side 406 would be relatively high and the ionomer concentration closest to the gas side 408 would be relatively low, as shown in FIG. 9b. Thus, a continuous gradient can be established, as shown in FIG. 9c.

After the electrode is made, as described above, additional spraying could serve to increase the ionomer content further on the top surface of the electrode. By way of a non-limiting example, different solvent systems, as previously described, could also serve to refine the gradient better.

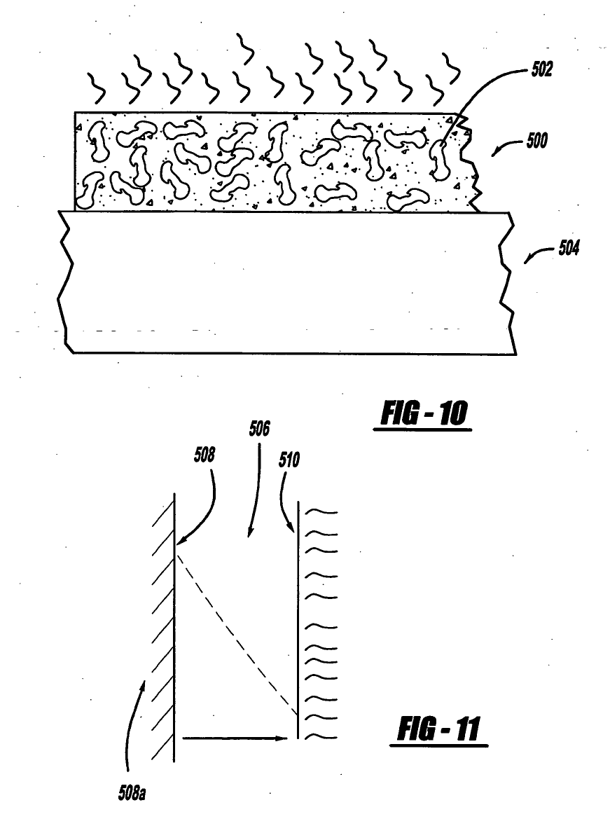

Catalyst inks can be used to prepare electrodes by coating of the inks onto porous decals, non-porous decals, and/or MPLs supported on DM substrates. The use of solvents with various boiling points in the electrode ink has a different effect when used in conjunction with non-porous decal supports. The ionomer gradient is now achieved during the drying stage, which is controlled by the solvent choice and the affinity of the ionomer and solvent for each other. By way of a non-limiting example, when high/low boiling point solvent mixtures are used, the ionomer would migrate to the top of the electrode, as shown in FIG. 10. Referring to FIG. 10, there is shown a catalyst layer 500 having an ionomeric material 502 contained therein, disposed on a non-porous decal 504. There is only one way for the solvents to escape, and that is from the top of the drying electrode. A low boiling point solvent would dry very quickly, effectively ‘freezing’ the ionomer in place. In contrast, a high boiling point solvent would volatilize more slowly, allowing the ionomer to migrate to the top surface with the evaporating solvent. Thus, the evaporating solvents would “drag” the ionomer to the top of the electrode 506 in the direction of the arrow, thus creating a natural gradient as shown in FIG. 11, with the membrane side 508 (i.e., nearest the membrane 508a) having a relatively high ionomer concentration and the gas side 510 having a relatively low ionomer concentration.

After the decal is made by the procedure previously described, additional spraying could serve to refine the ionomer gradient. Control of solvent systems in the ionomer overspray would also help to control the ionomer gradient better.

Hot-pressing is generally the final step wherein the catalyst-coated decal is bonded to the membrane by the use of heat and pressure. Tests have indicated that the combination of temperature and pressure can affect the amount of ionomer lost by intrusion into the porous web, e.g., away from the electrode. This provides for another control parameter, whereby the ionomer content in the electrode can be regulated.

For example, starting from a catalyst layer with high ionomeric content (e.g., typically I/C approximately 1.2 to 1.5/1), utilization of high hot-pressing pressures (e.g., greater than 500 psi) could lead to higher ionomer intrusion into the porous web, thus setting up a continuous ionomer gradient.

Both the multi-step and continuous ionomeric gradient-creation techniques, all of which are described above, can be combined with over spraying steps in between, e.g., to aid in good quality catalyst transfer to the membrane during hot-pressing. There are other ways of creation of such ionomeric gradients. Examples are provided below.

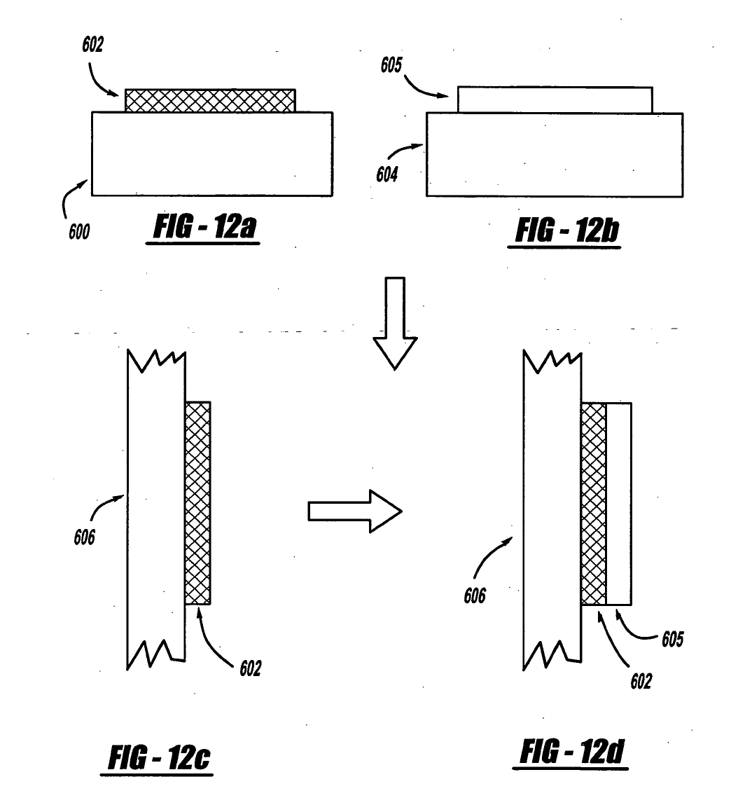

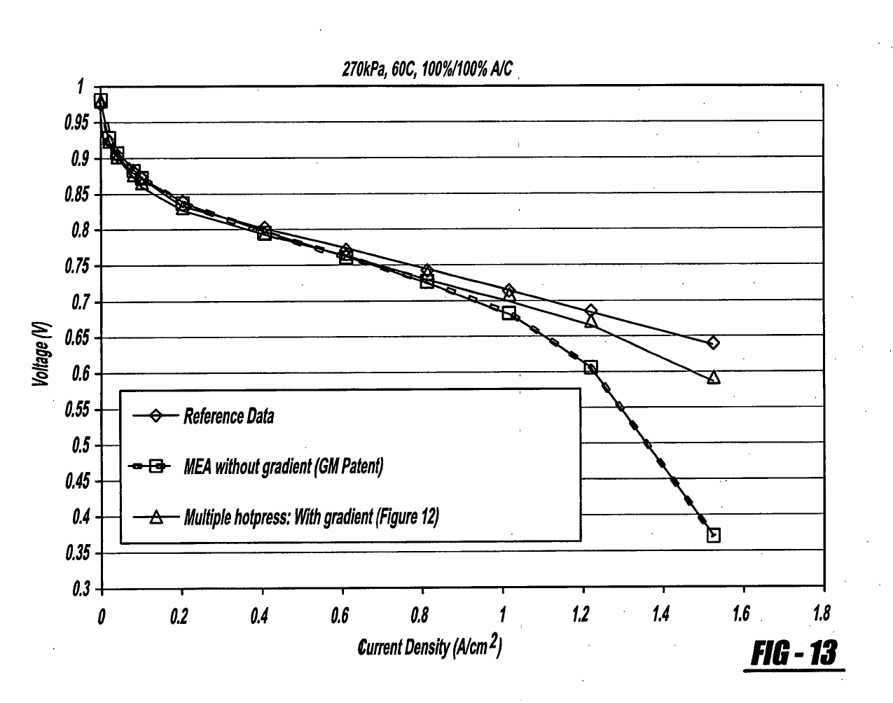

In accordance with one aspect of the present invention, individual decals can be coated with desired ionomer content, e.g., such as 0.5/1 (I/C) and 1.5/1 (I/C). Hot pressing is then carried out of the high ionomer content decal to membrane first, followed by a second hot pressing step to transfer the low ionomer content catalyst layer to the membrane. The process is shown schematically in FIGS. 12a-12d. In FIG. 12a, a decal 600 is provided with a catalyst layer 602 having a relatively high ionomer concentration (e.g., I/C ratio=1.5/1). In FIG. 12b, a decal 604 is provided with a catalyst layer 605 having a relatively low ionomer concentration (e.g., I/C ratio=0.5/1), for example, by overspraying an ionomer solution. In FIG. 12c, a first hot pressing step is performed wherein the high ionomer catalyst layer 602 is transferred to a membrane portion 606. In FIG. 12d, a second hot pressing step is performed wherein the low ionomer catalyst layer 605 is transferred to the high ionomer catalyst layer 602. It should be noted that such a process could be used both for porous and non-porous supports. In addition, multiple catalyst layers can be used to create a multilayer structure.

FIG. 13 shows performance of an MEA made with gradient on the cathode electrode, in comparison with an MEA made without a gradient. At higher current densities, there is an improvement of over 50 mV which is quite significant.

Such composite electrode structures can also be created by spraying the catalyst inks directly on the membrane. Commonly assigned U.S. patent application Ser. No. 10/763,633 to Yan et al., the entire specification of which is expressly incorporated herein by reference, describes the concept of spraying catalyst ink onto a membrane to create an MEA. This application also describes multiple spraying steps to build up the electrode structures. Accordingly, it is perceivable that the first layer of ink sprayed onto the membrane could contain the higher ionomer content. After the first layer is dried off, subsequent catalyst layers built up by spraying inks with progressively reducing ionomer content.

As previously noted, the catalyst layers can also be created on diffusion media. Commonly assigned U.S. patent application Ser. No. 10/763,514 to Yan et al., the entire specification of which is expressly incorporated herein by reference, describes the general concept of creation of CCDMs and CCDM-laminated membranes. Like the spraying onto membrane method previously described herein, it is conceivable that the multiple coatings of catalyst inks with changing ionomer content could create a catalyst layer with step-changing ionomer content. In addition, a roll-coating process could be set up to coat a microporous layer first on the DM, followed by sintering of the layer. Multiple layers of catalyst layers with changing ionomeric content can then be coated and dried to create a CCDM. It should be noted that the ionomer gradient could be the same with the lowest ionomer content in the catalyst layer closest to the DM. The ionomer content would then increase toward the top of the electrode (e.g., towards side intended to be nearest the membrane). This CCDM can then be bonded to the membrane.

As previously noted, CCDMs have long been known in the art, specifically in phosphoric acid fuel cells. In PEMFC technology, state-of-the art MEAs are considered to be CCMs. As previously described, these MEAs are fabricated through the decal transfer process, leaving the electrode bonded directly to the MEA. From a performance standpoint, the CCM has always yielded a more desirable power curve as well as better water management at high current densities (i.e., when mass transport dominates the cell performance). However, the CCDM has become more desirable from a manufacturing point of view due to the fact that it is conceivable to process everything on a roll to roll process with no decal transfer step. The following aspect of the present invention focuses on a processing parameter that enhances water management of the CCDM MEA.

It is known in the art that after the catalyst layer is deposited onto a given substrate (e.g., decal for CCM and carbon fiber paper for CCDM), an additional amount of ionomer is deposited onto the catalyst layer. This additional ionomer serves to increase the proton conductivity of the catalyst layer, enhance the interfacial properties between the catalyst layer and the membrane, and aid in bonding the decal (or catalyst coated diffusion media) to the membrane.

It is also commonly known in the art that once the decal or catalyst coated diffusion media is considered ready to be joined with the membrane, they are commonly mated by exposure to both temperature and pressure. The temperature chosen during this hot pressing procedure is determined primarily by the materials set, specifically the membrane. It is desirable that the membrane and the ionomer layer on the catalyst will soften and join together to form an optimal interface. In accordance with one aspect of the present invention, this is achieved by using a temperature at or exceeding the glass transition temperature of the membrane, commonly called the Tg.

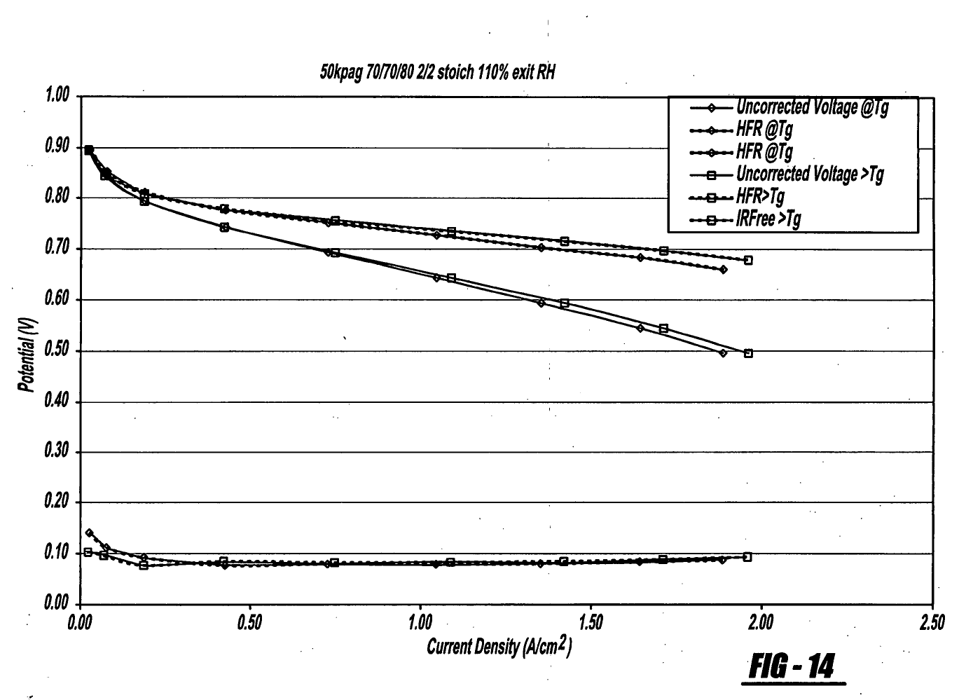

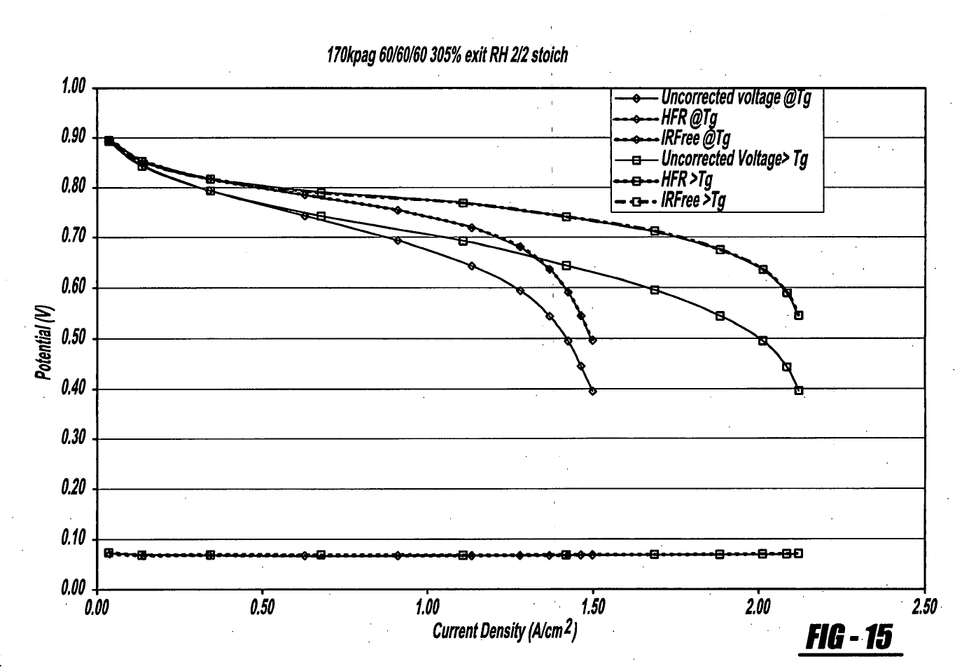

In accordance with one aspect of the present invention, it has been observed that varying the temperature at which the components are mated significantly affects the water management properties of the cell under operating fuel cell conditions. Referring to FIGS. 14 and 15, there are shown graphical illustrations of the potential versus current density properties of two exemplary MEAs.

The only variable in this comparison is the hot pressing temperature. For the membrane used in this experiment, the Tg was 130° C. One of the MEAs was fabricated by using this temperature. A second MEA was joined using a hot pressing temperature of 146° C. It is obvious that under moderate operating conditions (e.g., 50 kpag 70/70/80 2/2 stoichiometry) shown in FIG. 14, there is little difference in the performance between the two cells. However, under wetter operating conditions (e.g., 170 kpag, 60/60/ 2/2 stoichiometry) shown in FIG. 15, there is a drastic difference in the polarization curves. This condition is significant due to transient conditions, e.g., startup, freeze starts, and/or the like. The CCDM cell that experienced a higher MEA assembly temperature performed much better at high current densities. Without being bound to a particular theory of the operation of the present invention, it is believed that the hypothesis behind this behavior is that at these higher temperatures one may be actually moving the ionomer overcoat or film further into the catalyst layer, creating a gradient of ionomer in this overall structure and that it can be achieved by altering the processing conditions during CCDM MEA assembly.

The ink used for making the decals for CCMs are the same as that used in making the CCDMs. After the catalyst layer is coated and dried, the CCDMs are bonded to the membrane by hot-pressing. The conditions for hot-pressing are different for the CCDMs though. To reduce the instance of DM over-compression which may lead to mass transport losses in an operating fuel cell, the hot-pressing pressure is set at about 150 psi, which is different from the 200-500 psi used in CCM preparation.

The catalyst-coated membrane part of a “half and half MEA” is made according to the method previously described herein. Care needs to be taken that the catalyst layer attached to the membrane has an ionomer/carbon ratio that is high (e.g., about 0.8 to about 3). Next, a second catalyst layer is coated onto the microporous layer-coated diffusion medium. Care needs to be taken that the catalyst layer has a low ionomer/carbon ratio (0.2-0.8). To bond the two halves of the MEA together, the CCDM may or may not be sprayed with ionomer solution to create a thin layer of ionomer solution. Thereafter, the CCDM is bonded to the CCM at the same hot-press conditions as used to make a regular CCDM.

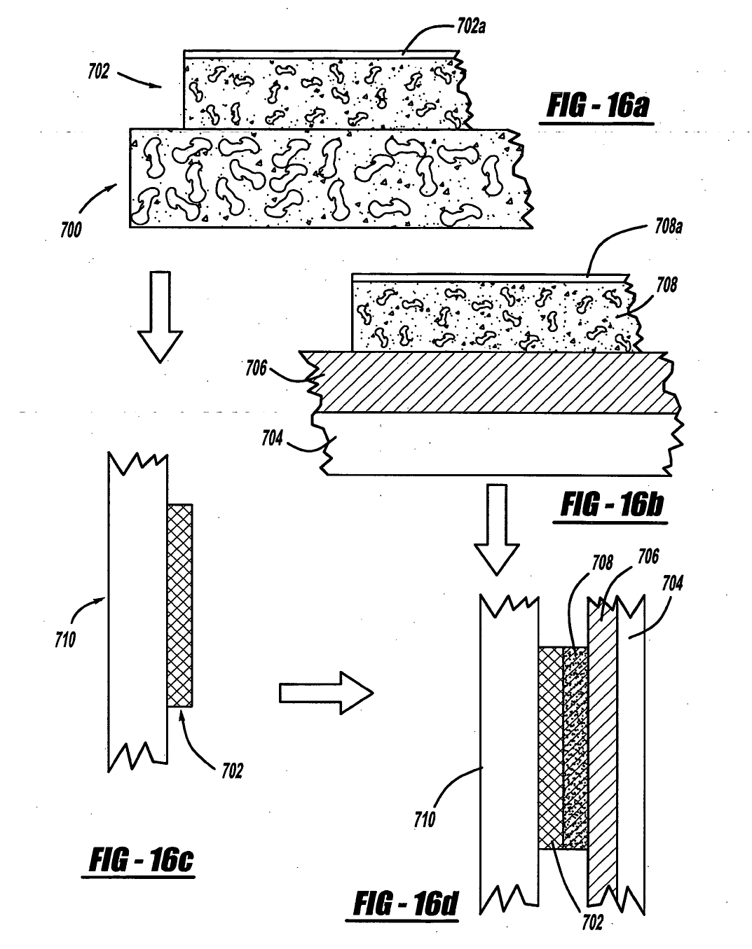

Referring to FIGS. 16a-16d, the procedure is shown schematically therein. In FIG. 16a, a decal 700 (e.g., ePTFE) is provided with a catalyst layer 702 having a relatively high ionomer concentration (e.g., I/C ratio=1.5/1) layer 702a applied thereto. In FIG. 16b, a diffusion medium 704, having a microporous layer 706 (e.g., carbon and a fluoropolymer), is provided with a catalyst layer 708 having a relatively low ionomer concentration (e.g., I/C ratio=0.5/1) layer 708a applied thereto, for example, by overspraying an ionomer solution. In FIG. 16c, a first hot pressing step is performed wherein the high ionomer catalyst layer 702 is transferred to a membrane portion 710. In FIG. 16d, a second hot pressing step is performed wherein the low ionomer catalyst layer 708 is laminated to the high ionomer catalyst layer 702 to form an ionomeric gradient (i.e., high to low as the catalyst layer extends away from the membrane).

The thickness of the catalyst layers in the CCM and the CCDM halves of the MEA may be individually changed according to the operating requirements of the MEA in the fuel cell. One may or may not choose to include an ionomer layer on top of the CCDM (e.g., to aid with the bonding process). Care needs to be taken, however, that if an ionomeric layer is coated on the CCDM, the ionomer layer is thin, e.g., on the order of about 0.2 to about 0.5 micrometers. This is so that the ionomer layer does not become a barrier for gas transport between the two halves.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electrode catalyst layer for use in a fuel cell, comprising:
a catalyst portion; and
an ionomeric material disposed in the catalyst portion;
wherein the concentration of the ionomeric material forms a gradient wherein the concentration of the ionomeric material decreases or increases with respect to a first surface of the catalyst portion to a second spaced and opposed surface of the catalyst portion.

2. The invention according to claim 1, wherein the first or second surface includes an ionomer/carbon (I/C) ratio in the range of about 0.8 to about 3.

3. The invention according to claim 1, wherein the first or second surface includes an ionomer/carbon (I/C) ratio in the range of about 1 to about 2.

4. The invention according to claim 1, wherein the first or second surface includes an ionomer/carbon (I/C) ratio in the range of about 0.1 to about 1.0.

5. The invention according to claim 1, wherein the first or second surface includes an ionomer/carbon (I/C) ratio in the range of about 0.2 to about 0.8.

6. The invention according to claim 1, further comprising a membrane in abutting relationship to the electrode catalyst layer.

7. The invention according to claim 6, wherein the first surface is in abutting relationship with the membrane.

8. The invention according to claim 7, wherein the first surface includes an ionomer/carbon (I/C) ratio in the range of about 0.8 to about 3.

9. The invention according to claim 7, wherein the first surface includes an ionomer/carbon (I/C) ratio in the range of about 1 to about 2.

10. The invention according to claim 6, wherein the second surface is spaced and opposed from the membrane.

11. The invention according to claim 10, wherein the second surface includes an ionomer/carbon (I/C) ratio in the range of about 0.1 to about 1.0.

12. The invention according to claim 10, wherein the second surface includes an ionomer/carbon (I/C) ratio in the range of about 0.2 to about 0.8.

13. The invention according to claim 6, wherein the concentration of the ionomeric material is highest in proximity to the membrane.

14. A catalyst-coated membrane, comprising:
an electrode catalyst layer disposed on a surface of the membrane;
wherein the electrode catalyst layer comprises:
a catalyst portion; and
an ionomeric material disposed in the catalyst portion;
wherein the concentration of the ionomeric material forms a gradient wherein the concentration of the ionomeric material is highest in proximity to the surface of the membrane.

15. The invention according to claim 14, wherein the electrode catalyst layer includes an ionomer/carbon (I/C) ratio in the range of about 0.8 to about 3.

16. The invention according to claim 14, wherein the electrode catalyst layer includes an ionomer/carbon (I/C) ratio in the range of about 1 to about 2.

17. The invention according to claim 14, wherein the electrode catalyst layer includes an ionomer/carbon (I/C) ratio in the range of about 0.1 to about 1.0.

18. The invention according to claim 14, wherein the electrode catalyst layer includes an ionomer/carbon (I/C) ratio in the range of about 0.2 to about 0.8.

19. The invention according to claim 14, wherein a surface of the electrode catalyst layer disposed on the surface of the membrane includes an ionomer/carbon (I/C) ratio in the range of about 0.8 to about 3.

20. The invention according to claim 14, wherein a first surface of the electrode catalyst layer disposed on the surface of the membrane includes an ionomer/carbon (I/C) ratio in the range of about 1 to about 2.

21. The invention according to claim 20, further comprising a second surface of the electrode catalyst layer disposed on the surface of the membrane, wherein the second surface is spaced and opposed from the membrane.

22. The invention according to claim 21, wherein the second surface includes an ionomer/carbon (I/C) ratio in the range of about 0.1 to about 1.0.

23. The invention according to claim 21, wherein the second surface includes an ionomer/carbon (I/C) ratio in the range of about 0.2 to about 0.8.

24. A catalyst-coated diffusion medium, comprising:
an electrode catalyst layer disposed on a surface of the diffusion medium;
wherein the electrode catalyst layer comprises:
a catalyst portion; and
an ionomeric material disposed in the catalyst portion;
wherein the concentration of the ionomeric material forms a gradient wherein the concentration of the ionomeric material is lowest in proximity to the surface of the diffusion medium.

25. The invention according to claim 24, wherein the electrode catalyst layer includes an ionomer/carbon (I/C) ratio in the range of about 0.8 to about 3.

26. The invention according to claim 24, wherein the electrode catalyst layer includes an ionomer/carbon (I/C) ratio in the range of about 1 to about 2.

27. The invention according to claim 24, wherein the electrode catalyst layer includes an ionomer/carbon (I/C) ratio in the range of about 0.1 to about 1.0.

28. The invention according to claim 24, wherein the electrode catalyst layer includes an ionomer/carbon (I/C) ratio in the range of about 0.2 to about 0.8.

29. The invention according to claim 24, wherein a surface of the electrode catalyst layer disposed on the surface of the diffusion medium includes an ionomer/carbon (I/C) ratio in the range of about 0.1 to about 1.

30. The invention according to claim 24, wherein a first surface of the electrode catalyst layer disposed on the surface of the diffusion medium includes an ionomer/carbon (I/C) ratio in the range of about 0.2 to about 0.8.

31. The invention according to claim 30, further comprising a second surface of the electrode catalyst layer disposed on the surface of the diffusion medium, wherein the second surface is spaced and opposed from the diffusion medium.

32. The invention according to claim 31, wherein the second surface includes an ionomer/carbon (I/C) ratio in the range of about 0.8 to about 3.

33. The invention according to claim 31, wherein the second surface includes an ionomer/carbon (I/C) ratio in the range of about 1 to about 2.

34. A membrane electrode assembly, comprising:
a membrane;
a cathode catalyst layer; and
an anode catalyst layer;
wherein either the anode or cathode catalyst layer is disposed on a surface of the membrane;
wherein either anode or cathode catalyst layer comprises:
a catalyst portion; and
an ionomeric material disposed in the catalyst portion;
wherein the concentration of the ionomeric material forms a gradient wherein the concentration of the ionomeric material is highest in proximity to the surface of the membrane.

35. The invention according to claim 34, wherein either the cathode or anode catalyst layer includes an ionomer/carbon (I/C) ratio in the range of about 0.8 to about 3.

36. The invention according to claim 34, wherein either the cathode or anode catalyst layer includes an ionomer/carbon (I/C) ratio in the range of about 1 to about 2.

37. The invention according to claim 34, wherein either the cathode or anode catalyst layer includes an ionomer/carbon (I/C) ratio in the range of about 0.1 to about 1.0.

38. The invention according to claim 34, wherein either the cathode or anode catalyst layer includes an ionomer/carbon (I/C) ratio in the range of about 0.2 to about 0.8.

39. The invention according to claim 34, wherein a surface of either the anode or cathode catalyst layer disposed on the surface of the membrane includes an ionomer/carbon (I/C) ratio in the range of about 0.8 to about 3.

40. The invention according to claim 34, wherein a first surface of either the cathode or anode catalyst layer disposed on the surface of the membrane includes an ionomer/carbon (I/C) ratio in the range of about 1 to about 2.

41. The invention according to claim 40, further comprising a second surface of either the cathode or anode catalyst layer disposed on the surface of the membrane, wherein the second surface is spaced and opposed from the membrane.

42. The invention according to claim 41, wherein the second surface includes an ionomer/carbon (I/C) ratio in the range of about 0.1 to about 1.0.

43. The invention according to claim 41, wherein the second surface includes an ionomer/carbon (I/C) ratio in the range of about 0.2 to about 0.8.

44. A membrane electrode assembly, comprising:
a membrane;
a catalyst layer; and
a diffusion medium;
wherein the catalyst layer is disposed on a surface of either the membrane or the diffusion medium;
wherein the catalyst layer comprises:
a catalyst portion; and
an ionomeric material disposed in the catalyst portion;
wherein the concentration of the ionomeric material forms a gradient wherein the concentration of the ionomeric material is highest in proximity to the surface of the membrane.

45. The invention according to claim 44, wherein the catalyst layer includes an ionomer/carbon (I/C) ratio in the range of about 0.8 to about 3.

46. The invention according to claim 44, wherein the catalyst layer includes an ionomer/carbon (I/C) ratio in the range of about 1 to about 2.

47. The invention according to claim 44, wherein the catalyst layer includes an ionomer/carbon (I/C) ratio in the range of about 0.1 to about 1.0.

48. The invention according to claim 44, wherein the catalyst layer includes an ionomer/carbon (I/C) ratio in the range of about 0.2 to about 0.8.

49. The invention according to claim 44, wherein a surface of the catalyst layer disposed on the surface of the membrane includes an ionomer/carbon (I/C) ratio in the range of about 0.8 to about 3.

50. The invention according to claim 44, wherein a first surface of the catalyst layer disposed on the surface of the membrane includes an ionomer/carbon (I/C) ratio in the range of about 1 to about 2.

51. The invention according to claim 50, further comprising a second surface of the catalyst layer disposed on the surface of the diffusion medium, wherein the second surface is spaced and opposed from the membrane.

52. The invention according to claim 51, wherein the second surface includes an ionomer/carbon (I/C) ratio in the range of about 0.1 to about 1.0.

53. The invention according to claim 51, wherein the second surface includes an ionomer/carbon (I/C) ratio in the range of about 0.2 to about 0.8.

54. A method of forming an electrode catalyst layer for use in a fuel cell, comprising:
providing a catalyst portion, wherein the catalyst portion includes a solvent and an ionomeric material;
coating the catalyst portion onto a surface of a substrate; and
drying the solvent;
wherein the ionomeric material is operable to migrate through the catalyst portion so as to form a gradient therein.

55. The invention according to claim 54, wherein the solvent and the ionomeric material have an affinity for one another.

56. The invention according to claim 54, wherein the solvent is comprised of a material selected from the group consisting of water, alcohol, a water-alcohol mixture, and combinations thereof.

57. The invention according to claim 54, wherein the substrate is comprised of a component selected from the group consisting of a porous decal, a non-porous decal, a microporous layer, a diffusion medium, and combinations thereof.

58. The invention according to claim 54, wherein the solvent has a drying rate such that the ionomeric material does not substantially migrate through the catalyst portion during the drying step.

59. The invention according to claim 54, wherein the solvent has a drying rate point such that the ionomeric material substantially migrates through the catalyst portion during the drying step.
